(19) United States
(12) Patent Application Publication
(10) Pub. No.: US 2014/0025537 A1
(43) Pub. Date: Jan. 23, 2014

(54) VERIFYING ACCESSORY COMPATIBILITY WITH A MOBILE DEVICE

(71) Applicants: Praveen VENKATARAMU, Bridgewater, NJ (US); Ioannis Tsampalis, Bridgewater, NJ (US)

(72) Inventors: Praveen VENKATARAMU, Bridgewater, NJ (US); Ioannis Tsampalis, Bridgewater, NJ (US)

(73) Assignee: Cellco Partnership d/b/a Verizon Wireless, Basking Ridge, NJ (US)

(21) Appl. No.: 13/555,776

(22) Filed: Jul. 23, 2012

(51) Int. Cl. G06Q 30/00

(52) U.S. Cl. 705/26.61

(57) ABSTRACT

Systems and techniques for providing an automated interface that enables a user of a mobile station to quickly determine whether a hardware accessory or mobile station accessory of interest is compatible with the mobile station are provided. A determination is made whether or not the mobile station accessory product is compatible with the mobile station based on the type of the mobile station and information identifying the mobile station accessory product. A message or notification indicating whether or not the mobile station accessory product is compatible with the first mobile station is automatically displayed to the user of the mobile station via an interface provided at the mobile station.

### BACKGROUND

The advancement of mobile communication devices and networks in recent years has led to a significant increase in the number of different mobile devices that are in use today. Consumers in the market for a mobile device may select from a wide variety of different types of devices. In addition to the variety of mobile devices, a plethora of hardware accessories may be available for use with each type or version of a particular mobile device. Examples of such hardware accessories may include, but are not limited to, wireless or hands-free headsets, battery chargers, protective cases, display screen protection films, etc.

However, a user in the market for a new hardware accessory for the user's mobile device may experience difficulty in selecting an accessory that is suitable for the user's particular device. This is primarily due to the variety of hardware accessories that may be available in the market for any given type of mobile device. For example, each individual hardware accessory may be compatible with only a specific type of mobile device (e.g., based on device manufacturer) or specific version of version of the mobile operating system or computing platform associated with the device. Determining whether a particular hardware accessory is compatible with a mobile device generally involves the user having to manually search for compatibility information related to a particular hardware accessory and mobile device by, for example, speaking with a customer sales representative in a physical retail store or manually browsing a web site of an accessory or device manufacturer.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary communication system offering a variety of communication services, including communications for verifying the compatibility of a hardware accessory with a user's mobile device.

FIG. 2 is a block diagram illustrating an exemplary system for automatically verifying the compatibility of a hardware accessory with a user's mobile device via a client application executing at the mobile device.

FIG. 3 is a flowchart of an exemplary server process for automatically verifying the compatibility of a hardware accessory with a user's mobile device based on a request from a client application executing at the mobile device.

FIG. 4 is a high-level functional block diagram of an example mobile device for practicing an embodiment of the subject technology.

FIG. 5 is a simplified functional block diagram of an example computer that may be configured as a host or server.

FIG. 6 is a simplified functional block diagram of an example personal computer or other work station or terminal device.

### DETAILED DESCRIPTION OF PREFERRED EMBODIMENTS

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The various technologies discussed below and shown by way of examples in the drawings relate to providing an automated interface that enables a user of a mobile device (also referred to herein as a mobile station) to quickly determine whether a hardware accessory of interest is compatible with (e.g., is known to be functional with or supported by) the user's mobile device. For example, such an interface would allow the user to check the compatibility of newly released or updated hardware accessories that are not already registered with the user's mobile device (e.g., as part of a mobile account of the user for mobile communication services provided by a wireless carrier or mobile communication network operator). The user identifies or supplies information identifying a hardware accessory product of interest via an interface at the mobile device, and a computer system analyzes relevant compatibility information with respect to the hardware accessory and the user's mobile station. As will be described in further detail below, the analysis performed by the computer system may include, for example and without limitation, comparing relevant properties identified for the specific mobile device (e.g., the manufacturer, model number, type and version number of the mobile operating system or computing platform) with previously stored compatibility information indicating the operating requirements (e.g., minimum hardware requirements) of the particular hardware accessory. The computer system may then determine whether or not the identified properties of the specific mobile device meet the requirements of the hardware accessory based on this comparison. Compatibility results (based on the above analysis) from the computer system are displayed at the mobile device. Hence, the methodology provides the desired answer with regard to mobile device compatibility, automatically without any further user interaction.

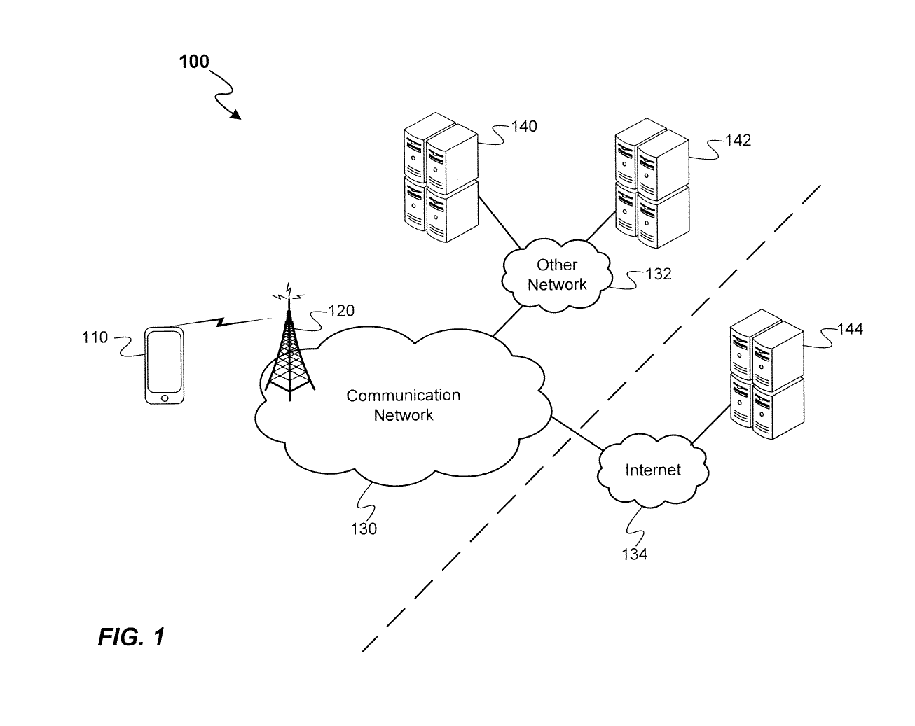

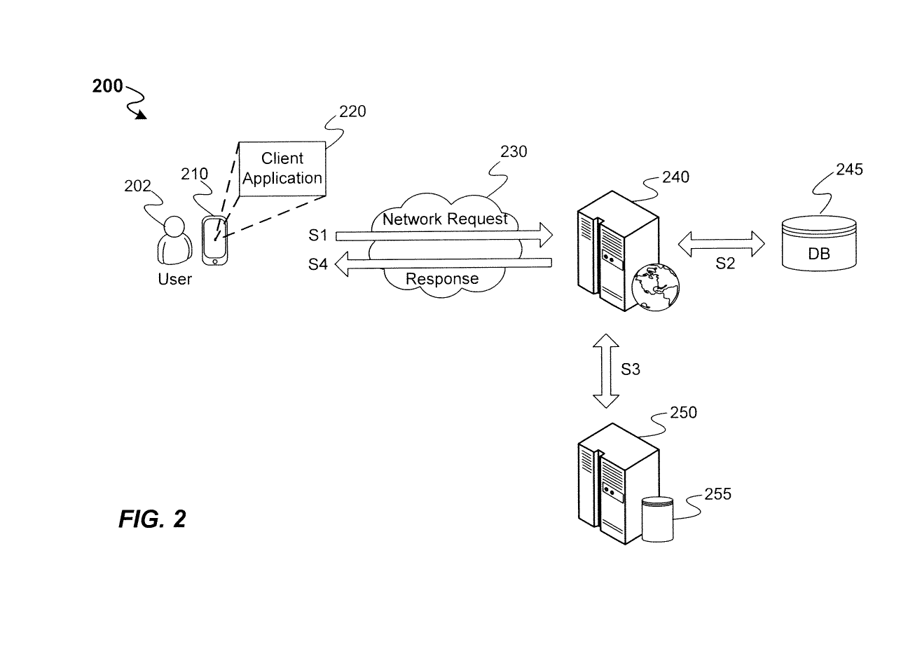

Reference now is made in detail to the examples illustrated in the accompanying drawings and discussed below. FIG. 1 illustrates an example communication network system 100 in which portions of the subject technology may be implemented. As will be described in further detail below, network system 100 provides a variety of communication services between different clients and servers, including communications for providing an automated way for a user of a mobile device to quickly determine whether a hardware accessory of interest is compatible with the user's mobile device. Following the description of network system 100, example network elements and processes related to providing an automated interface at the user's mobile device that enables the user to quickly determine whether a hardware accessory of interest is compatible with the particular mobile device will be described further below with respect to the examples illustrated in FIGS. 2-6.

In the example illustrated in FIG. 1, network system 100 includes a client device 110, which communicate request messages to one or more servers 140, 142 and 144 through a communication network 130, which can include, for example, one or more interconnected networks such as a network 132 and the Internet 134. As noted above, system 100 as illustrated in FIG. 1 can be used to provide a variety of communications, including communications for an automated interface provided to a user at client device 110 that enables the user to verify the compatibility of a hardware accessory of interest for use with client device 110. For example, client device 110 can be configured to execute a client application or service, which communicates through communication network 130 with a verification service that checks relevant hardware accessory compatibility information and that is hosted at one or more of servers 140 or 142. Further, servers 140 or 142 can be configured to provide such a verification service by enabling various types of functionality (e.g., in the form of different functions of the service) to client device 110 through a local area network or wide area network such as the Internet (134).

Network 130 of system 100 facilitates communications between various types of clients and at least one server for purposes of client access to the functionality of a service hosted at the server. Such functionality can be implemented in the form of an automated interface including one or more processing functions accessible to client device 110, as described above. In addition, network 130 further supports communications for devices that do not execute client applications or participate in any particular service hosted at any of servers 140. Network 130 can thus be any network or combination of networks in an overall communication network for transmitting data communications between various devices associated with the communication network. Network 130 can include, but is not limited to, a wired (e.g., Ethernet) or a wireless (e.g., WiFi or 4G) network. In addition, network 130 can include a local area network, medium area network, and/or wide area network. Network 130 can support protocols and technology including, but not limited to, Internet or World Wide Web protocols and communication services. Intermediate network routers, gateways, or servers may be provided between the network components/devices of system 100 as may be desired in some implementations of network or computing environments.

While the example in FIG. 1 shows only client device 110, system 100 can be used to facilitate data communications for additional devices (not shown) over communication network 130. Similarly, system 100 can include other servers (not shown) in addition to servers 140, 142 and 144 for receiving request messages from one or more of the client devices. Furthermore, the present techniques may be implemented in communication network 130 using any of a variety of available communication networks and/or on any type of computing device compatible with such a network. As such, FIG. 1 is used herein to provide only a very simplified example of a few relevant elements of system 100 and network 130, for purposes of discussion and explanation of the subject technology.

The functionality of a particular web service is generally provided for the benefit of a user of a client device via a client application program, process, or interface (or simply “client”) that is executed on the device for enabling data communications with an associated application server through communication network 130. For example, the client may be implemented on device 110 as a web interface for a web service hosted at one of servers 140, 142 and 144. Such a web interface may be used by each respective user of the client devices to access the functions of the web service during execution of a web browser application on the device. Alternatively, the client may be a dedicated application program that is installed and executed on either device specifically for enabling the user to access the functionality provided by a particular web service.

The above-described client application for providing an automated interface for a user to verify hardware accessory compatibility for their respective devices can be configured to execute on many different types and configurations of computing devices. The client device 110 is intended to provide just one example of a type of client device that may be used for communicating request messages to a web service hosted at one or more of server(s) 140, 142, and 144. In the example shown in FIG. 1, client device 110 is a mobile station configured to access mobile wireless communication services through network 130, for example, via a base station 120. Thus, client device 110 can be any type of mobile computing device capable of data communications over one or more networks. However, it should be noted that the subject technology is not intended to be limited to mobile devices and may be implemented using a desktop or any other type of personal computing device. An example implementation of a computing device that is capable of implementing the above-described client application will be described further below in reference to FIG. 2.

FIG. 2 is a block diagram illustrating an example system 200 for automatically verifying the compatibility of a hardware accessory with a user's mobile device via a client application executing at the mobile device. For purposes of discussion, system 200 will be described with reference to one or more of the components in system 100 of FIG. 1, as described above, but system 200 is not intended to be limited thereto. In the example shown in FIG. 2, a mobile device 210 of a user 202 communicates with an application or web server 240 through a network 230. Mobile device 210 can be any type of mobile computing device with at least one processor, a memory, a display and one or more user input devices (e.g., a touch-screen display, QWERTY keyboard or T9 keypad). Examples of such mobile computing devices include, but are not limited to, portable handsets, smart-phones, tablet computers and personal digital assistants. Mobile device 210 also may be implemented using, for example, client device 110 of system 100 of FIG. 1, as described above, but mobile device 210 is not intended to be limited thereto.

Network 230 can be any network or combination of networks in an overall mobile communication network for transmitting data communications between various devices associated with the mobile communication network 230. Network 230 can include, but is not limited to, a wired (e.g., Ethernet) or a wireless (e.g., Wi-Fi or 3G) network. In addition, network 230 can include, but is not limited to, a local area network, medium area network, and/or wide area network such as the Internet. Network 230 can support protocols and technology including, but not limited to, Internet or World Wide Web protocols and communication services. Using the example system 100 of FIG. 1, network 230 may be implemented using, for example, one or more of networks 130, 132 and 134, as described above. Intermediate network devices (e.g., routers, gateway devices or other servers) can be provided between the components of system 200 as may be desired when implementing the subject technology as described herein.

In some implementations, the interface provided by client application 220 enables user 202 to input or supply a unique identifier for identifying a particular hardware accessory of interest. For example, user 202 may be in the market (e.g., at a physical retail store) for a new hardware accessory for the user's 202 mobile device 210. The unique identifier may be, for example, a universal product code (UPC) or other conventional or carrier-specific identifier that may be used to identify a particular hardware accessory. Other examples of unique identifiers include, but are not limited to, an Radio-Frequency Identification (RFID) tag identifier or quick response (QR) code associated with the particular hardware accessory. The unique identifier may be supplied via a user input device of the mobile device 210. For example, the user may input the unique identifier for an accessory of interest into a text field displayed in the interface using a keyboard or touch-screen of the mobile device 210 or may be scanned in using, for example, a camera or other data input device integrated with or coupled to the mobile device 210. In an example, the unique identifier may be provided to client application 220 via a data input device coupled to the mobile device 210. Examples of such data input devices may include, but are not limited to, a scanner device, digital camera (e.g., for capturing/scanning an image of a UPC or QR code), barcode reader, or near field communication (NFC) reader device for reading RFID/NFC tags.

Upon acquiring the unique identifier for the hardware accessory (e.g., from any of the aforementioned data input devices that may be coupled to the mobile device 210), client application 220 executing at device 210 may be configured to automatically send the unique identifier as part of a network request to server 240 over network 230, as shown in FIG. 2 (at S1). The unique identifier may be, for example, a universal product code (UPC) or other conventional or carrier-specific identifier that may be used to identify a particular hardware accessory. For example, the network request may be in the form of a Hyper Text Transfer Protocol (HTTP) request message sent from client application 220 to server 240 through network 230, and the unique identifier (e.g., UPC value) of a hardware accessory may be included in the body of the request for processing by server 240. In some implementations, client application 220 may be a web browser and thus, the interface provided to user 202 at device 210 may be a web interface in a web page loaded within the web browser. In a different example, upon capturing or scanning the unique identifier of the hardware accessory, the data input device itself may be configured to send the captured accessory identifier directly to server 240 over network 230. In this example, the data input device may include a processor, memory and network communication interface for communicating with network 230. The memory of the data input device may be used, for example, to store information associated with mobile device 210. As will be described further below, such information may include, but is not limited to, a unique device identifier associated with the mobile device 210. Examples of such a unique device identifier include, but are not limited to, the mobile equipment identifier (MEID) and the International Mobile Equipment Identity (IMEI) value, in accordance with relevant telecommunication industry standards. For example, the data input device may be preconfigured with the unique device identifier of mobile device 210 or may be transferred programmatically (e.g., via a function provided by client application 220 for this purpose) from the mobile device 210 to the data input device when the input device is initially coupled or installed with the mobile device 210. As such, the data input device may also be configured to send the unique device identifier of the mobile device 210 along with the captured unique identifier of the hardware accessory.

In response to receiving the network request including the unique identifier associated with a hardware accessory of interest from mobile device 210, server 240 may retrieve (S2) compatibility information related to the particular hardware accessory of interest or hardware accessories in general for mobile device 210. As shown in FIG. 2, this information may be retrieved from database 245 or other local or remote data store communicatively coupled to server 240. Additionally or alternatively, this information may be retrieved (S3) from another computing device, for example, a remote server system 250 accessible to server 240 through the network 230 or other network (e.g., a private network). The remote server system 250 may be associated with, for example, a manufacturer of the hardware accessory of interest corresponding to the unique identifier included in the network request. For example, server 240 may determine that information corresponding to the hardware accessory is not available in database 245 and in response to this determination, may be configured to send a query requesting information related to the hardware accessory to the remote server system 250. The remote server system 250 may include a local data store or database 255 for storing hardware accessory compatibility information for various types of mobile devices. Such hardware accessory compatibility information may be stored at database 245 or database 255 using, for example, a lookup table (e.g., hash table) or other data structure for efficiently sorting and retrieving compatibility information for one or more hardware accessories based on a particular type of device (e.g., device 210).

Server 240 may then determine whether the hardware accessory of interest is compatible with the particular mobile device of the user, based on the retrieved compatibility information (S2 or S3) and the unique identifier included in the network request (S1) from the mobile device. As part of this process, server 240 may first attempt to identify the particular type of mobile device 210 based on information specific to the device. Examples of such device-specific information that server 240 may use to identify the particular device may include, but are not limited to, the manufacturer of the device, model number, type and version number of the mobile operating system or computing platform and/or any other information that may be used to identify the particular device. In an example, the device-specific information may be stored in a memory of device 210 and sent from the device 210 (e.g., by client application 220) to server 240 via network 230. For example, this information may be sent in conjunction with the unique accessory identifier in the network request (S1) sent by client application 220, as described above.

In another example, device-specific information may be stored in, for example, database 245 or other data store that is accessible to server 240. Further, the device information may be stored in association with other information used to identify user 202 or a mobile account of user 202. The mobile account of user 202, in turn, may be associated with, for example, a carrier or operator of a mobile communication network (e.g., network 230) that provides voice and data communication services to user 202. Information associated with the user's 202 mobile account may include, for example, a unique operator or billing identifier specific to user 202. An example of such a unique operator identifier may include, but is not limited to, a mobile directory number (MDN) or phone number associated with the mobile device 210 or user 202.

Further, mobile account information for user 202, including any unique operator identifier(s), may be stored in association with a unique device identifier specific to mobile device 210. Such a unique device-specific identifier assigned to mobile device 210 may be, for example, a unique identifier specific to device 210. For example, such a unique device identifier may be assigned to device 210 by the device manufacturer or operating system provider. As described above, different types of unique or device-specific identifiers that may be used to identify a particular device may include, but are not limited to, the mobile equipment identifier (MEID) and the International Mobile Equipment Identity (IMEI) number. However, it should be noted that the aforementioned types of unique or device-specific identifiers are provided by way of example only, and that the techniques described herein are not limited thereto.

As noted above, server 240 may use the obtained hardware accessory identifier and device-specific information to determine whether the hardware accessory of interest is compatible with the particular mobile device 210 of user 202. The server can then send a response (S4) through network 230 to the client application 220 executing at the mobile device 210 based on the determination. Like the network request sent from device 210, the response from the server 240 may be in the form of a HTTP message. The response from server 240 may include compatibility information for client application 220 to use based on, for example, the results of the compatibility determination made by server 240.

Alternatively, the determination of whether the hardware accessory is compatible may be made by client application 220 based on the information included in the response from server 240. For example, client application 220 may use the information from server 240 only for purposes of identifying relevant properties (e.g., model and version number) of the specified hardware accessory of interest. Client application 220 may then use the additional information related to the particular accessory and the device (e.g., as provided by server 240) to determine or verify compatibility with device 210. In this example, client application 220 may be configured to perform operations similar to the operations performed by server 240 in making the compatibility determination, as described above. For example, client application 220 may perform a look-up operation or query a table of hardware accessory information stored in a local or remote data store accessible to device 210. It should be noted that such a table generally may be limited to hardware accessory information specific to device 210 (e.g., so as to conserve storage space at device 210).

Upon receiving the response from server 240, client application 220 may be configured to provide a notification indicating to user 202 the results of the compatibility determination with respect to the hardware accessory of interest (e.g., as performed either locally by client application 220 at device 210 or remotely by server 240, as described above). Client application 220 may use any one or a combination of various techniques for providing such a notification to user 202. In some implementations, client application 220 may provide a visual notification using, for example, a display of device 210. Such a visual notification may be in the form of, for example, a pop-up or dialog window including a message alerting user 202 to the compatibility verification results.

Using the previously described example of storing device-specific information in association with mobile account information for user 202, the techniques described herein may be extended further to other devices (e.g., other mobile devices) or hardware accessories that may be associated with the user. For example, the account information stored for user 202 (e.g., in a database of a carrier's mobile communication network) and may include the user's 202 purchase history including a record of prior transactions and indicating other devices or accessories that were recently purchased or currently owned by user 202. Such information may be used to further check or verify the compatibility of the present hardware accessory of interest with the other devices or accessories that are known to be owned by or associated with user 202 (by using similar techniques, as described above). In addition, the compatibility results for such other devices may be included in the server response and notification displayed to user 202 at the mobile device 210, as described above. The user's 202 relevant purchase or account history may be, for example, restricted to a predetermined time window (e.g., within the last year) or alternatively, may include all devices purchased since the user opened the account. Similar types of devices that are known to be no longer in use or replaced by a newer device/model (e.g., older models of the same phone) may be ignored.

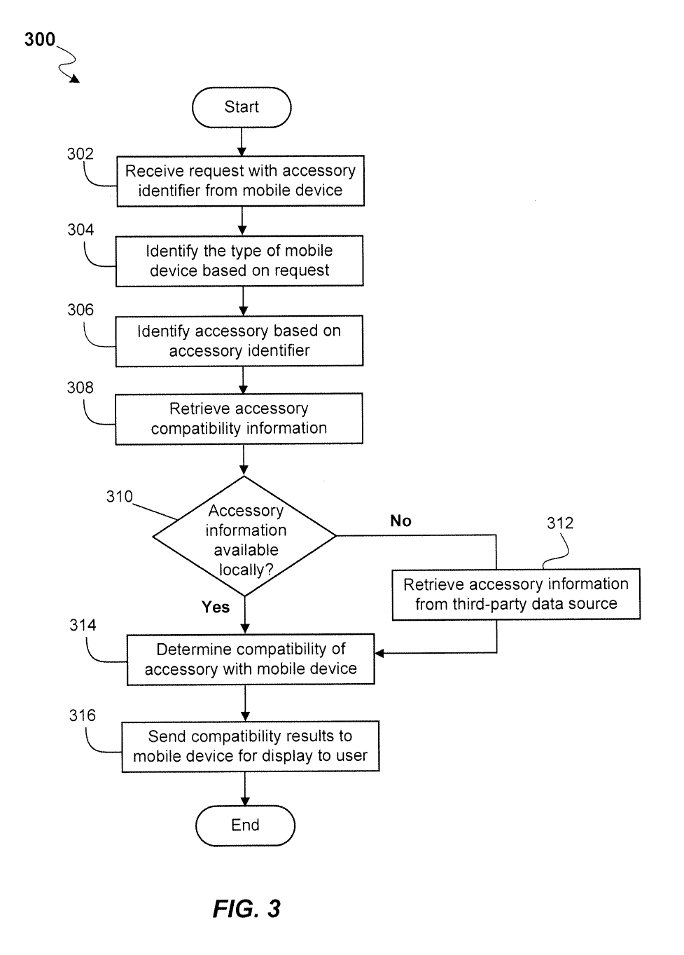

Additional examples and description related to these techniques including, for example, operations of mobile device 210 and/or server 240, are provided below with respect to the example method illustrated in FIG. 3.

FIG. 3 is a process flowchart of an example method 300 for automatically verifying the compatibility of a hardware accessory with a mobile station of a user based on a request from a client application executing at the mobile station. For purposes of discussion, method 300 will be described using system 200 of FIG. 2, as described above, but method 300 is not intended to be limited thereto. Further, method 300 will be described in the context of a client application program (e.g., client application 220 of system 200) executed at a mobile device (e.g., mobile device 210 of system 200). The mobile device is communicatively coupled to an application server (e.g., application server 240) via a mobile communication network (e.g., network 230 of system 200). Thus, the steps of method 300 may be performed by, for example, server 240 of system 200 of FIG. 2, as described above. However, it should be noted that method 300 can be executed on other types of client devices such as, for example and without limitation, a PDA, a laptop or personal computer, and similar types of devices capable of providing an automated interface that enables a user to verify the compatibility of a hardware accessory of interest with a given device.

Method 300 begins in step 302, which includes receiving at the server a request or query message from the mobile device via the network. The request may be from the client application executing at the mobile device. As described above, the client application may provide an interface enabling the user of the device to supply or capture (e.g., using a digital camera, bar code scanner, etc.) information identifying a hardware accessory product of interest. This information may be, for example, a unique identifier associated with the particular hardware accessory. Examples of such unique identifiers may include, but are not limited to, a universal product code (UPC), an RFID tag and quick response (QR) code associated with the hardware accessory product. In some implementations, the unique identifier for the hardware accessory may be associated with a particular carrier or operator of a mobile communication network. In response to receiving the unique identifier for the hardware accessory (e.g., from a data input device coupled to the mobile device), the client application executing at the device may be configured to send the received unique identifier to the application server over a network, automatically without any further user interaction.

Upon receiving the request including the accessory identifier information, method 300 proceeds to steps 304 and 306, in which the type of mobile device and the particular hardware accessory of interest are identified, respectively, based on the received request. The accessory is identified by the server using the accessory identifier information included in the request, as described above. In an example, the server may identify the mobile device of the user as one of a plurality of types of mobile devices based on device information associated with the user (or user account, e.g., for mobile communication services), which may be stored in a data store accessible to the server. In a different example, relevant information related to the user's mobile device may be stored in a memory of the device and included along with the unique accessory identifier in the network request sent to the server. The device information may include, for example and without limitation, the type of mobile device, model number, type and version number of the mobile operating system and/or any other information that may be used to identify the particular mobile device.

In response to receiving the request including the unique identifier associated with a hardware accessory of interest from the mobile device of the user, the server may retrieve compatibility information related to the identified hardware accessory of interest specifically with respect to the identified mobile device (step 308). This information may be retrieved from a local data store (step 310) communicatively coupled to the server or from another computing device (step 312), for example, a remote server system accessible through the network. The remote system may be associated with, for example, the manufacturer of the hardware accessory of interest corresponding to the unique identifier included in the network request. In step 314, it is determined (e.g., by server 240 of FIG. 2, as described above) whether or not the accessory product is compatible with the mobile device based on the retrieved compatibility information corresponding to the identified type of mobile device (e.g., mobile device 210 of FIG. 2, as described above) and the information identifying a hardware accessory product. Step 314 may include, for example, comparing relevant properties identified for the specific mobile device (e.g., the manufacturer, model number, type and version number of the mobile operating system or computing platform) with the retrieved compatibility information indicating the operating requirements of the particular hardware accessory, as described previously. Such operating requirements may include, for example, specific hardware requirements or only a set of minimum hardware requirements, depending on the particular hardware accessory in question. Accordingly, step 314 may further include determining, based on this comparison, whether or not the identified properties of the specific mobile device meet the requirements of the particular hardware accessory, as indicated by the retrieved compatibility information. In step 316, a response or answer message is sent to the mobile device through the network (e.g., via the interface provided by the client application executing at the device). This response may be sent by, for example, the server hosting the compatibility service (e.g., server 240 of FIG. 2, as described above) or a different server (e.g., third-party server 250 of FIG. 2). The response message indicates the results of the determination of whether or not the mobile station accessory product is compatible with the mobile station. Further, the message sent to the mobile device may be presented to the user at the mobile device (e.g., as a notification displayed using a display of the device).

In contrast with conventional solutions, the above-described techniques enable a user of a mobile device to efficiently verify the compatibility of a specified hardware accessory product of interest (e.g., based on information captured directly at the device) with the user's specific device automatically, and without any further user interaction. Further, these techniques allow the user to obtain and view the results of a compatibility determination with respect to the hardware accessory at the user's device with relatively little delay (e.g., in substantially real time).

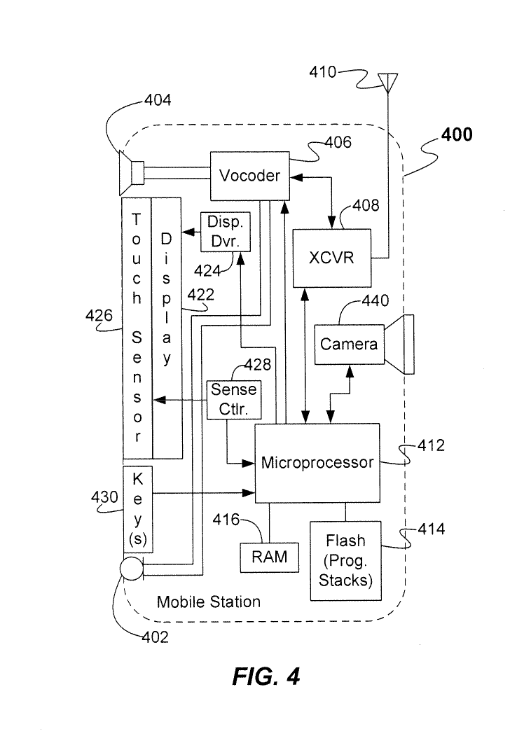

FIG. 4 illustrates a general block diagram of an example mobile device in the form of a mobile handset. For illustration purposes, the present teachings will be described below in reference to a touch-screen type mobile device. In particular, FIG. 4 depicts a touch-screen type mobile device 400 (e.g., a smart phone device or tablet computer). However, the structure and operation of the touch-screen type mobile device 400, as will be described in further detail below, is provided by way of example, and the subject technology as described herein is not intended to be limited thereto. It should be appreciated that the disclosed subject matter may be implemented in a non-touch screen type mobile device or in other mobile or portable devices having communication and data processing capabilities. Examples of such mobile devices may include, but are not limited to, net-book computers, tablets, notebook computers and the like. Referring back to FIGS. 1 and 2, the relevant functional elements/aspects of user devices 110 and 210, respectively, may be implemented using the example mobile device 400 illustrated in FIG. 4.

For purposes of discussion, FIG. 4 provides a block diagram illustration of an exemplary mobile device 400 having a touch-screen user interface. As such, mobile device 400 can be any smart mobile device (e.g., smart-phone or tablet device). Although possible configured somewhat differently, at least logically, a number of the elements of the exemplary touch-screen type mobile device 400 are similar to the elements of mobile device 400, and are identified by like reference numbers in FIG. 4. For example, the touch-screen type mobile device 400 includes a microphone 402, speaker 404 and vocoder 406, for audio input and output functions, much like in the earlier example. The mobile device 400 also includes a at least one digital transceiver (XCVR) 408, for digital wireless communications, although the mobile device 400 may include an additional digital or analog transceiver. The concepts discussed here encompass embodiments of the mobile device 400 utilizing any digital transceivers that conform to current or future developed digital wireless communication standards. As in mobile device 400, the transceiver 408 provides two-way wireless communication of information, such as vocoded speech samples and/or digital information, in accordance with the technology of a network, as described above. The transceiver 408 also sends and receives a variety of signaling messages in support of the various voice and data services provided via the mobile device 400 and the communication network. Each transceiver 408 connects through RF send and receive amplifiers (not separately shown) to an antenna 410. The transceiver may also support various types of mobile messaging services, such as short message service (SMS), enhanced messaging service (EMS) and/or multimedia messaging service (MMS).

As in the example of mobile device 400, a microprocessor 412 serves as a programmable controller for the mobile device 400, in that it controls all operations of the mobile device 400 in accord with programming that it executes, for all general operations, and for operations involved in the procedure for obtaining operator identifier information under consideration here. Mobile device 400 includes flash type program memory 414, for storage of various program routines and mobile configuration settings. The mobile device 400 may also include a non-volatile random access memory (RAM) 416 for a working data processing memory. Of course, other storage devices or configurations may be added to or substituted for those in the example. Hence, as outlined above, the mobile device 400 includes a processor, and programming stored in the flash memory 414 configures the processor so that the mobile device is capable of performing various desired functions, including in this case the functions associated with a client application executing on the mobile device, involved in the techniques for providing advanced data services by the carrier.

In the example shown in FIG. 4, the user input elements for mobile device 400 include a touch-screen display 422 (also referred to herein as “display screen 422” or simply, “display 422”) and a keypad including one or more hardware keys 430. For example, the keypad may be implemented as a sliding keyboard of mobile device 400 and keys 430 may correspond to the keys of such a keyboard. Alternatively, the hardware keys 430 (including keyboard) of mobile device 400 may be replaced by soft keys presented in an appropriate arrangement on the touch-screen display 422. The soft keys presented on the touch-screen display 422 may operate similarly to hardware keys and thus, can be used to invoke the same user interface functions as with the hardware keys.

In general, the touch-screen display 422 of mobile device 400 is used to present information (e.g., text, video, graphics or other content) to the user of the mobile device. Touch-screen display 422 may be, for example and without limitation, a capacitive touch-screen display. In operation, touch-screen display 422 includes a touch/position sensor 426 for detecting the occurrence and relative location of user input with respect to the viewable area of the display screen. The user input may be an actual touch of the display device with the user's finger, stylus or similar type of peripheral device used for user input with a touch-screen. Use of such a touch-screen display as part of the user interface enables a user to interact directly with the information presented on the display.

Accordingly, microprocessor 412 controls display 422 via a display driver 424, to present visible outputs to the device user. The touch sensor 426 is relatively transparent, so that the user may view the information presented on the display 422. Mobile device 400 may also include a sense circuit 228 for sensing signals from elements of the touch/position sensor 426 and detects occurrence and position of each touch of the screen formed by the display 422 and sensor 426. The sense circuit 428 provides touch position information to the microprocessor 412, which can correlate that information to the information currently displayed via the display 422, to determine the nature of user input via the screen. The display 422 and touch sensor 426 (and possibly one or more keys 430, if included) are the physical elements providing the textual and graphical user interface for the mobile device 400. The microphone 402 and speaker 404 may be used as additional user interface elements, for audio input and output, including with respect to some functions related to the automated hardware accessory compatibility determination feature, as described herein.

In the illustrated example of FIG. 4, the mobile device 400 also includes a digital camera 440, for capturing still images and/or video clips. Although digital camera 440 is shown as an integrated camera of mobile device 400, it should be noted that digital camera 440 may be implemented using an external camera device communicatively coupled to mobile device 400. The user may, for example, operate one or more keys 430 or provide input via touch sensor 426 (e.g., via a soft key displayed via the touch-screen display 422) to take a still image, which essentially activates the camera 440 to create a digital representation of an optical image visible to the image sensor through the lens of the camera. For example, the image may be of a UPC or QR code associated with a mobile station accessory product, as described previously. The camera 440 supplies the digital representation of the image to the microprocessor 412, which stores the representation as an image file in one of the device memories. The microprocessor 412 may also process the image file to generate a visible image output as a presentation to the user on the display 422, when the user takes the picture or at a later time when the user recalls the picture from device memory. Video images could be similarly processed and displayed. An audio file or the audio associated with a video clip could be decoded by the microprocessor 412 or the vocoder 406, for output to the user as an audible signal via the speaker 404.

As shown by the above discussion, functions relating to the interface for automatically verifying the compatibility of a hardware accessory product of interest may be implemented on a mobile device of a user, as shown by user devices 110, 210 and 400 of FIGS. 1, 2 and 4, respectively. However, it should be noted that such functions are not limited thereto and that such functions also may be implemented using any general-purpose computing device including, for example and without limitation, a personal desktop computer or workstation device communicatively coupled to a camera or other image capturing device for capturing digital images.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for identifying a particular hardware accessory or mobile device, as described herein. The software code is executable by the general-purpose computer. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for automatically determining the compatibility of a hardware accessory product with the user's device, in essentially the manner performed in the implementations discussed and illustrated herein.

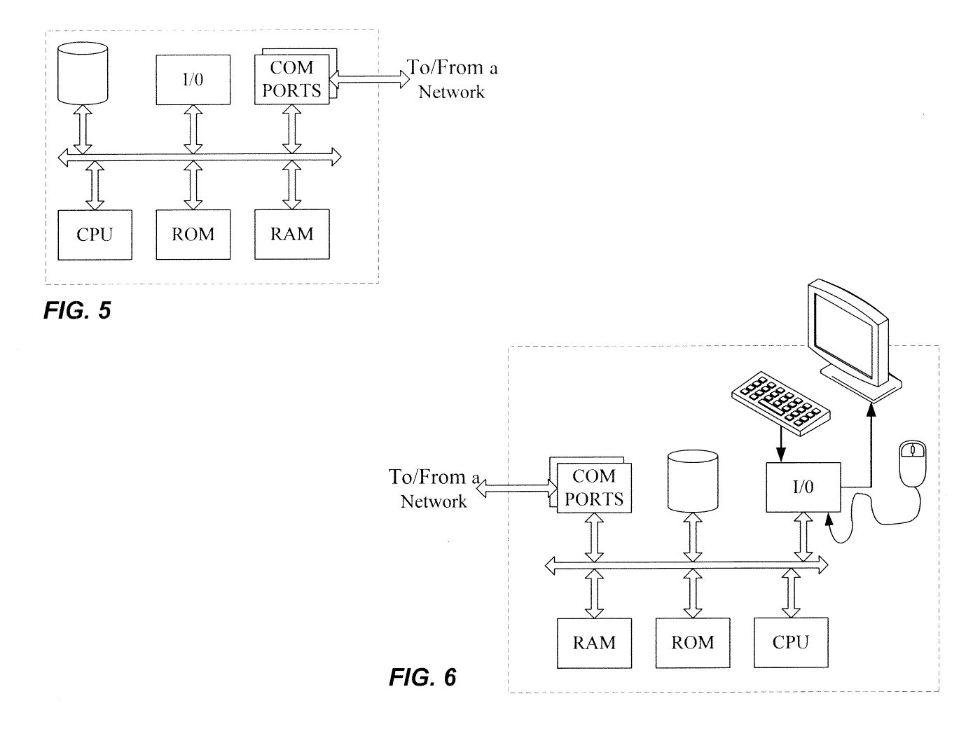

FIGS. 5 and 6 are functional block diagrams illustrating general purpose computer hardware platforms. FIG. 5 illustrates a network or host computer platform, as may typically be used to implement a server (e.g., any of servers 140, 142 or 144 of FIG. 1 or servers 240 or 250 of FIG. 2, as described above). FIG. 6 depicts a computer with user interface elements, as may be used to implement a personal computer or mobile device (e.g., mobile device 210 of FIG. 2, as described above). It is believed that the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, the steps of the method 300 of FIG. 3, as described above, may be embodied in programming. Program aspects of the technology may be thought of as “products” or “articles of manufacture” typically in the form of executable code or process instructions and/or associated data that is stored on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a web service provider into the computer platform of the application or web server that will be hosting the web service.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as “computer' or “machine readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the steps of processes 200 and 300, as shown in FIGS. 2 and 3, as well as the security token functionality as described above with respect to FIGS. 4 and 5. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

As noted above, the computer as illustrated in the example of FIG. 7 may be a mobile computer with user interface elements, as may be used to implement a laptop, tablet or notebook computer or the like. For example, such a device may include a touch-screen display for user input and output. Alternatively, the device may include a standard light emitting diode (LED) display and, for example, an alphanumeric keypad or T9 keyboard. It is believed that the structure, programming, and general operation of such computing equipment and as a result the drawing should be self-explanatory. As known in the data processing and communications arts, a mobile computer comprises a central processor or other processing device, an internal communication bus, various types of memory or storage media (RAM, ROM, EEPROM, cache memory, disk drives, etc.) for code and data storage, and one or more network interface cards or ports for communication purposes. Also, the mobile computer can further comprise various wireless transceiver modules (or components) such as GPS, WiFi, IrDA, Bluetooth, etc. The software functionalities involve programming, including executable code, associated stored data, and graphical user interface code for implementing a client application program at the mobile device. The software code is executable by the processor of the mobile computer. In operation, the code is stored within the mobile computer. At other times, however, the software may be stored at other locations and/or transported for loading into the appropriate mobile computer. Execution of such code by a processor of the mobile computer enables the mobile computer to implement the methodology for a client for requesting access to one or more functions offered by a web service, in essentially the manner performed in the implementation discussed and illustrated herein.

Further, the client can be implemented in a remote computer (or server) on a network. That is, a mobile device sends information (e.g., a request message, including a security token) to the remote server for requesting access to a function of a web service hosted at the server; and the remote server processes the request based on the security token for the client and returns an appropriate response to the mobile device over the network. In the example above, the mobile device operates as a client terminal and the remote computer as a server in a client-server network environment. While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer system, comprising:
an interface configured to enable communication through a network with a first mobile station;
a processor coupled to the interface;
a memory accessible to the processor; and
programming stored in the memory, wherein execution of the programming by the processor configures the computer system to perform functions, including functions to:
receive a query message from the first mobile station via the network and the interface, the query including information identifying a mobile station accessory product and information related to the first mobile station;
identify the first mobile station as one of a plurality of types of mobile stations based on the information related to the first mobile station;
based on the identified type of first mobile station and the information identifying the mobile station accessory product, determine whether or not the mobile station accessory product is compatible with the first mobile station; and
send an answer message to the first mobile station via the network and the interface, indicating the determination of whether or not the mobile station accessory product is compatible with the first mobile station, for presentation to a user of the first mobile station.

2. The system of claim 1, wherein the function to determine the compatibility comprises functions to:
identify the type of the first mobile station and the mobile station accessory product, to a computer system of a manufacture or supplier of the mobile station accessory product; and
receive the determination of whether or not the mobile station accessory product is compatible with the first mobile station, from the computer system of the manufacture or supplier of the mobile station accessory product.

3. The system of claim 1, wherein the function to determine the compatibility comprises functions to:
query a database for compatibility information related to the mobile station accessory product based on the identified type of the first mobile station and the information identifying the mobile station accessory product; and
determine whether or not the mobile station accessory product is compatible with the first mobile station based on the queried compatibility information.

4. The system of claim 1, wherein the information related to the first mobile station is at least one of a mobile equipment identifier associated with the first mobile station or a unique device identifier assigned to the first mobile station by a manufacturer of the first mobile station.

5. The system of claim 1, wherein the functions performed by the computer system further include functions to:
in response to the query message received from the first mobile station, identify at least one second mobile station associated with the user based on a purchase history including a record of prior transactions stored for the user in a database communicatively coupled to the computing system, wherein the second mobile station is identified as one of the plurality of types of mobile stations based on the stored information related to the second mobile station;
based on the identified type of second mobile station and the information identifying the mobile station accessory product, determine whether or not the mobile station accessory product is compatible with the second mobile station; and
update the answer message to be sent to the first mobile station via the network and the interface, so as to include an indication of whether or not the mobile station accessory product is compatible with the second mobile station based on the determination of compatibility for the second mobile station.

6. The system of claim 1, wherein the query message including the information identifying the mobile station accessory product was received via the network from a data input device that is coupled to the first mobile station and that captured the information identifying the mobile station accessory product.

7. The system of claim 6, wherein the information identifying the mobile station accessory product includes a radio-frequency identification (RFID) tag identifier, and the data input device is an RFID or a near field communication (NFC) reader.

8. The system of claim 6, wherein the information identifying the mobile station accessory product includes a universal product code (UPC) or a quick response (QR) code associated with the mobile station accessory product.

9. The system of claim 8, wherein the data input device is a digital camera.

10. A method, comprising:
receiving, at a server, a network request from a client application executing at a first mobile device of a user, the network request including a unique identifier associated with a hardware accessory product of interest to the user;
retrieving compatibility information related to hardware accessories for the first mobile device based on the received network request;
determining whether the hardware accessory product is compatible with the first mobile device of the user based on the retrieved compatibility information and the unique identifier included in the network request from the first mobile device; and
sending a response to the client application executing at the first mobile device based on the determination, the response including an indication, to be presented to the user at the first mobile device, of whether or not the hardware accessory product is compatible with the first mobile device.

11. The method of claim 10, wherein the retrieving step comprises:
identifying the first mobile device as one of a plurality of types of mobile devices based on information related to the mobile device included within the received network request; and
retrieving compatibility information related to hardware accessories for the first mobile device based on the identified type of the first mobile device.

12. The method of claim 11, wherein the retrieving step further comprises:
querying a database for the compatibility information related to the hardware accessory product based on the identified type of the first mobile device and the information identifying the hardware accessory product.

13. The method of claim 11, wherein the information related to the first mobile device includes at least one of a mobile equipment identifier associated with the first mobile device or a unique device identifier assigned to the first mobile device by a manufacturer of the first mobile device.

14. The method of claim 10, further comprising:
in response to the query message received from the first mobile device, identifying at least one second mobile device associated with the user based on a purchase history including a record of prior transactions stored for the user in a database communicatively coupled to the server device, wherein the second mobile device is identified as one of the plurality of types of mobile devices based on the stored information related to the second mobile device;
based on the identified type of the second mobile device and the unique identifier associated with the hardware accessory product, determining whether the hardware accessory product is compatible with the second mobile device; and
updating the response to be sent to the client application executing at the first mobile device based on the determination, wherein the response is updated so as to indicate to the user at the first mobile device whether or not the hardware accessory product is compatible with the second mobile device.

15. The method of claim 10, wherein the unique identifier associated with the hardware accessory product is captured using a data input device coupled to the first mobile device, and the network request is sent automatically by the client application executing at the first mobile device upon obtaining the unique identifier as captured by the data input device.

16. The method of claim 15, wherein the unique identifier associated with the hardware accessory product is based on radio-frequency identification (RFID), and the data input device is an RFID or a near field communication (NFC) reader.

17. The method of claim 15, wherein the unique identifier associated with the hardware accessory product is a universal product code (UPC) or a quick response (QR) code associated with the hardware accessory product.

18. The method of claim 17, wherein the data input device coupled to the first mobile device is a digital camera.

19. The method of claim 17, wherein the data input device coupled to the first mobile device is a barcode scanning device.

20. A mobile station, comprising:
a wireless transceiver configured to enable wireless communication through a mobile network;
at least one user interface element;
a processor coupled to the transceiver and the at least one user interface element;
a memory accessible to the processor; and
an application program stored in the memory, wherein execution of the application program by the processor configures the mobile station to perform functions, including functions to:
receive an input of information enabling identification of a mobile station accessory product;
send a query message via the transceiver and the network, the query including the information enabling identification of the mobile station accessory product and information related to the mobile station sufficient to enable identification of the mobile station as one of a plurality of types of mobile station;
receive answer indicating whether or not the mobile station accessory product is compatible with the mobile station, via the transceiver and the network; and
output to the user the indication of whether or not the mobile station accessory product is compatible with the mobile station via the at least one user interface element.
